(19) United States
(12) Patent Application Publication
(10) Pub. No.: US 2011/0244330 A1
(43) Pub. Date: Oct. 6, 2011

(54) ELECTRODE CONFIGURATION FOR BATTERIES

(75) Inventors: Jeffrey L. Swoyer, Port Washington, WI (US); Thomas J. Dougherty, Waukesha, WI (US)

(73) Assignee: Johnson Controls - SAFT Advanced Power Solutions LLC

(21) Appl. No.: 13/086,300

(22) Filed: Apr. 13, 2011

Related U.S. Application Data
(63) Continuation of application No. PCT/US2009/061324, filed on Oct. 20, 2009.
(60) Provisional application No. 61/107,225, filed on Oct. 21, 2008.

(51) Int. Cl. H01M 4/50; H01M 4/70; H01M 4/505; H01M 4/52; H01M 4/13915; F27D 21/00

(52) U.S. Cl. 429/221; 429/245; 429/223; 429/224; 429/231.3; 429/241; 29/623.1; 29/623.5; 432/18

(57) ABSTRACT

An electrode for an electrochemical cell including a polymer substrate, a conductive material in contact with the polymer substrate, a conductive ink in contact with the conductive material, and an active electrode material in contact with the conductive ink. The conductive ink is configured to enhance the adhesion between the conductive material and the active electrode material.

### CROSS-REFERENCE TO RELATED PATENT APPLICATIONS

This application is a continuation of International Patent Application No. PCT/US2009/061324 filed on Oct. 20, 2009, which claims the benefit of and priority to U.S. Provisional Patent Application No. 61/107,225, filed Oct. 21, 2008. The entire disclosures of International Patent Application No. PCT/US2009/061324 and U.S. Provisional Patent Application No. 61/107,225 are incorporated herein by reference.

### BACKGROUND

The present application relates generally to the field of batteries and battery systems. More specifically, the present application relates to batteries and battery systems that may be used in vehicle applications to provide at least a portion of the motive power for the vehicle.

Vehicles using electric power for all or a portion of their motive power (e.g., electric vehicles (EVs), hybrid electric vehicles (HEVs), plug-in hybrid electric vehicles (PHEVs), and the like, collectively referred to as “electric vehicles”) may provide a number of advantages as compared to more traditional gas-powered vehicles using internal combustion engines. For example, electric vehicles may produce fewer undesirable emission products and may exhibit greater fuel efficiency as compared to vehicles using internal combustion engines (and, in some cases, such vehicles may eliminate the use of gasoline entirely, as is the case with certain types of PHEVs).

As electric vehicle technology continues to evolve, there is a need to provide improved power sources (e.g., battery systems or modules) for such vehicles. For example, it is desirable to increase the distance that such vehicles may travel without the need to recharge the batteries. It is also desirable to improve the performance of such batteries and to reduce the cost associated with the battery systems.

One area of improvement that continues to develop is in the area of battery chemistry. Early electric vehicle systems employed nickel-metal-hydride (NiMH) batteries as a propulsion source. Over time, different additives and modifications have improved the performance, reliability, and utility of NiMH batteries.

More recently, manufacturers have begun to develop lithium-ion batteries that may be used in electric vehicles. There are several advantages associated with using lithium-ion batteries for vehicle applications. For example, lithium-ion batteries have a higher charge density and specific power than NiMH batteries. Stated another way, lithium-ion batteries may be smaller than NiMH batteries while storing the same amount of charge, which may allow for weight and space savings in the electric vehicle (or, alternatively, this feature may allow manufacturers to provide a greater amount of power for the vehicle without increasing the weight of the vehicle or the space taken up by the battery system).

It is generally known that lithium-ion batteries perform differently than NiMH batteries and may present design and engineering challenges that differ from those presented with NiMH battery technology. For example, lithium-ion batteries may be more susceptible to variations in battery temperature than comparable NiMH batteries, and thus systems may be used to regulate the temperatures of the lithium-ion batteries during vehicle operation. The manufacture of lithium-ion batteries also presents challenges unique to this battery chemistry, and new methods and systems are being developed to address such challenges.

A battery may include, among other components, a positive electrode, a negative electrode, one or more separators separating the positive electrode from the negative electrode, and an electrolyte material. Each electrode may include an active material that is coated or otherwise applied or secured to a current collector that is electrically coupled to a positive or negative terminal of the battery.

Active electrode layers having a thickness of between 20 and 40 micrometers are often desired for electrodes. Typical battery materials may have a small fraction of agglomerated particles which can be in excess of 20 micrometers, which may lead to difficulty in coating such thin layers and non-homogeneous dispersion of electrode components. Smaller particles can be produced, but may result in several challenges. For example, production of smaller particle size battery materials can lead to issues with excessive fines, which can act as an impurity. Production of smaller particles can also lead to increased cost due to added processing cost, as well as to difficulty in slurry dispersion due to increased surface area of the active material.

It would be desirable to provide an improved battery or battery module and/or system for use in electric vehicles that addresses one or more challenges associated with NiMH and/or lithium-ion battery systems used in such vehicles. It would also be desirable to provide a battery module and/or system that includes any one or more of the advantageous features that will be apparent from a review of the present disclosure.

### SUMMARY

An exemplary embodiment relates to an electrode for an electrochemical cell including a polymer substrate, a conductive material in contact with the polymer substrate, a conductive ink in contact with the conductive material, and an active electrode material in contact with the conductive ink. The conductive ink is configured to enhance the adhesion between the conductive material and the active electrode material.

Another exemplary embodiment relates to an electrochemical cell having an electrode including a polymer substrate, a conductive material provided on the polymer substrate, a conductive ink provided on the conductive material, and an active electrode material provided on the conductive ink. The conductive ink is configured to enhance the adhesion between the conductive material and the active electrode material.

Another exemplary embodiment relates to a method of making an electrode for an electrochemical cell. The method includes providing a conductive material on a polymer substrate. The method also includes providing an conductive ink on the conductive material. The method further includes providing an active electrode material on the conductive ink. The conductive ink is configured to enhance the adhesion between the conductive material and the active electrode material.

### BRIEF DESCRIPTION OF THE FIGURES

FIG. 1 is a perspective view of a vehicle including a battery module according to an exemplary embodiment.

FIG. 1A is a perspective view of a battery module according to an exemplary embodiment.

FIG. 2 is a cutaway schematic view of a vehicle including a battery module according to an exemplary embodiment.

FIG. 3 is a perspective view of an electrochemical cell according to an exemplary embodiment.

FIG. 4 is a partial cross-sectional view of the electrochemical cell shown in FIG. 3 taken along line 4-4 in FIG. 3.

FIG. 5 is a partial cross-sectional view of electrodes and separators for an electrochemical cell according to an exemplary embodiment.

FIG. 6 is an isometric view of a cell element provided in the form of a jelly roll configuration according to an exemplary embodiment.

FIG. 7 is a cross-sectional view of the cell element shown in FIG. 6 taken along line 7-7 in FIG. 6.

FIG. 8 is a perspective view showing an initial portion of the assembly of a cell element according to an exemplary embodiment.

FIG. 9 is a perspective view showing a final portion of the assembly of a cell element according to an exemplary embodiment.

FIG. 10A is a cross-sectional view of a portion of an electrode according to an exemplary embodiment.

FIG. 10B is a cross-sectional view of a portion of an electrode according to another exemplary embodiment.

FIGS. 11A-11D are detail views of a portion of a polymer substrate for an electrode according to various exemplary embodiments.

FIG. 12 is a flow diagram of a method of producing thin membrane electrodes according to an exemplary embodiment.

FIG. 13 is a flow diagram of a method of forming an active material to be deposited onto a thin membrane electrode according to an exemplary embodiment.

### DETAILED DESCRIPTION

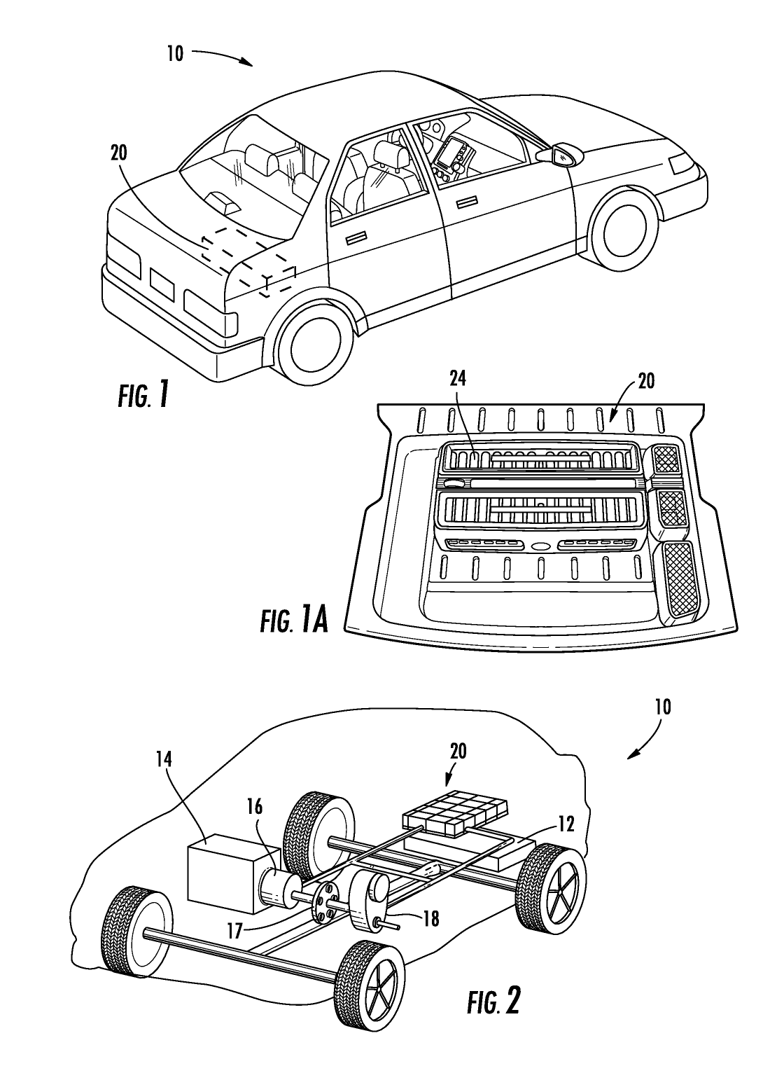

FIG. 1 is a perspective view of a vehicle 10 in the form of an automobile (e.g., a car) having a battery module 20 for providing all or a portion of the motive power for the vehicle 10. Such a vehicle 10 can be an electric vehicle (EV), a hybrid electric vehicle (HEV), a plug-in hybrid electric vehicle (PHEV), or other type of vehicle using electric power for propulsion (collectively referred to as “electric vehicles”).

Although the vehicle 10 is illustrated as a car in FIG. 1, the type of vehicle may differ according to other exemplary embodiments, all of which are intended to fall within the scope of the present disclosure. For example, the vehicle 10 may be a truck, bus, industrial vehicle, motorcycle, recreational vehicle, boat, or any other type of vehicle that may benefit from the use of electric power for all or a portion of its propulsion power.

Although the battery module 20 is illustrated in FIG. 1 as being positioned in the trunk or rear of the vehicle, according to other exemplary embodiments, the location of the battery module 20 may differ. For example, the position of the battery module 20 may be selected based on the available space within a vehicle, the desired weight balance of the vehicle, the location of other components used with the battery module 20 (e.g., battery management systems, vents or cooling devices, etc.), and a variety of other considerations.

FIG. 1A is a perspective view of a battery module 20 according to an exemplary embodiment. According to an exemplary embodiment, the battery module 20 includes electrochemical batteries or cells 24, and includes features or components for connecting the electrochemical cells 24 to each other and/or to other components of the vehicle electrical system, and also for regulating the electrochemical cells 24 and other features of the battery module 20. For example, the battery module 20 may include features that are responsible for monitoring and controlling the electrical performance of the battery module 20, managing the thermal behavior of the battery module 20, containment and/or routing of effluent (e.g., gases that may be vented from a cell 24), and other aspects of the battery module 20.

FIG. 2 illustrates a cutaway schematic view of a vehicle 10 provided in the form of an HEV according to an exemplary embodiment. A battery module 20 is provided toward the rear of the vehicle 10 proximate a fuel tank 12 (the battery module 20 may be provided immediately adjacent the fuel tank 12 or may be provided in a separate compartment in the rear of the vehicle 10 (e.g., a trunk) or may be provided elsewhere in the vehicle 10). An internal combustion engine 14 is provided for times when the vehicle 10 utilizes gasoline power to propel the vehicle 10. An electric motor 16, a power split device 17, and a generator 18 are also provided as part of the vehicle drive system.

Such a vehicle 10 may be powered or driven by just the battery module 20, by just the engine 14, or by both the battery module 20 and the engine 14. It should be noted that other types of vehicles and configurations for the vehicle drive system may be used according to other exemplary embodiments, and that the schematic illustration of FIG. 2 should not be considered to limit the scope of the subject matter described in the present application.

According to various exemplary embodiments, the size, shape, and location of the battery module 20, the type of vehicle 10, the type of vehicle technology (e.g., EV, HEV, PHEV, etc.), and the battery chemistry, among other features, may differ from those shown or described.

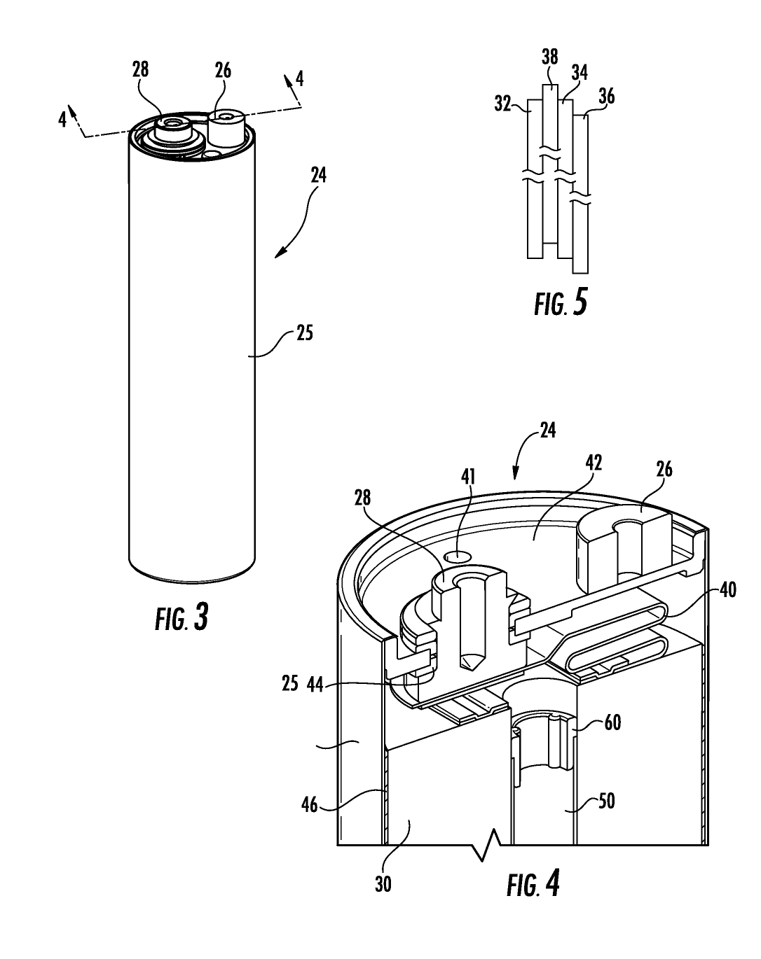

Referring now to FIG. 3, an isometric view of an electrochemical cell 24 is shown according to an exemplary embodiment. The battery module 20 includes a plurality of such electrochemical batteries or cells 24 (e.g., lithium-ion cells, nickel-metal-hydride cells, lithium polymer cells, etc., or other types of electrochemical cells now known or hereafter developed). According to an exemplary embodiment, the electrochemical cells 24 are generally cylindrical lithium-ion cells configured to store an electrical charge. According to other exemplary embodiments, the cells 24 could have other physical configurations (e.g., oval, prismatic, polygonal, etc.). The capacity, size, design, terminal configuration, and other features of the cells 24 may also differ from those shown according to other exemplary embodiments.

FIG. 4 is a partial cross-sectional view of a cell 24 such as that shown in FIG. 3 taken along line 4-4 in FIG. 3. According to an exemplary embodiment, the cell 24 includes a container or housing 25, a cap or cover 42, and a cell element 30. According to an exemplary embodiment, the cell element 30 is a wound cell element that includes at least one cathode or positive electrode 36, at least one anode or negative electrode 38, and one or more separators 32, 34. The separators 32, 34 are provided intermediate or between the positive and negative electrodes 36, 38 to electrically isolate the electrodes 36, 38 from each other. According to an exemplary embodiment, the cell 24 includes an electrolyte (not shown). According to an exemplary embodiment, the electrolyte is provided in the housing 25 of the cell 24 through a fill hole 41.

According to an exemplary embodiment, the cell element 30 has a wound configuration in which the electrodes 36, 38 and separators 32, 34 are wound around a member or element provided in the form of a tube or mandrel 50. Such a configuration may be referred to alternatively as a jelly roll configuration. Although the mandrel 50 is shown as being provided as having a generally cylindrical shape, according to other exemplary embodiments, the mandrel 50 may have a different configuration (e.g., it may have an oval or rectangular cross-section shape, etc.). It is noted that the cell element 30, although shown as having a generally cylindrical shape, may also have a different configuration (e.g., it may have an oval, rectangular, or other desired cross-section shape).

According to another exemplary embodiment, the electrochemical cell 24 may be a prismatic cell having prismatic or stacked cell elements (not shown). In such an embodiment, the positive and negative electrodes 36, 38 are provided as plates that are stacked upon one another in an alternating fashion, with the separators 32, 34 provided intermediate or between the positive and negative electrodes 36, 38 to electrically isolate the electrodes 36, 38 from each other.

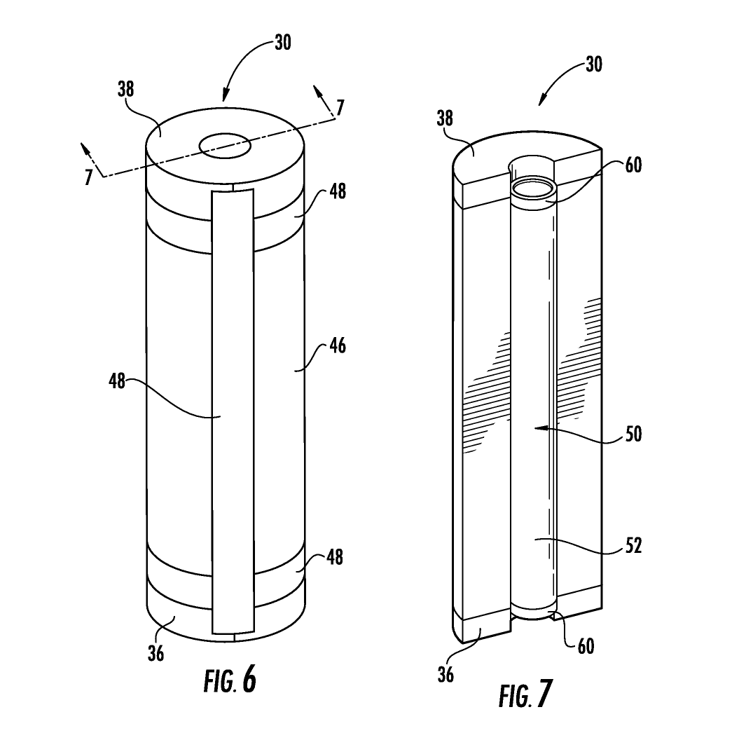

According to an exemplary embodiment, the positive electrode 36 is offset from the negative electrode 38 in the axial direction as shown in the partial cross-sectional view shown in FIG. 5. Accordingly, at a first end of the cell element 30, the wound positive electrode 36 will extend further than the negative electrode 38, and at a second (opposite) end of the cell element 30, the negative electrode 38 will extend further than the positive electrode 36.

One advantageous feature of such a configuration is that current collectors may be connected to a specific electrode at one end of the cell 24 without contacting the opposite polarity electrode. For example, according to an exemplary embodiment, a negative current collector 40 (e.g., as shown in FIG. 4) may be connected to the exposed negative electrode 38 at one end of the cell element 30 and a positive current collector (not shown) may be connected to the exposed positive electrode 36 at the opposite end of the cell element 30.

According to an exemplary embodiment, the negative current collector 40 electrically connects the negative electrode 38 to the negative terminal 28 of the cell 24. The negative terminal 28 is insulated from the cover 42 of the housing 25 by an insulator 44, as shown in FIG. 4. According to an exemplary embodiment, the positive current collector (not shown) electrically connects the positive electrode 36 to a bottom of the housing 25. The housing 25 is electrically connected to the cover 42 (e.g., as shown in FIG. 4), which in turn is electrically connected to the positive terminal 26.

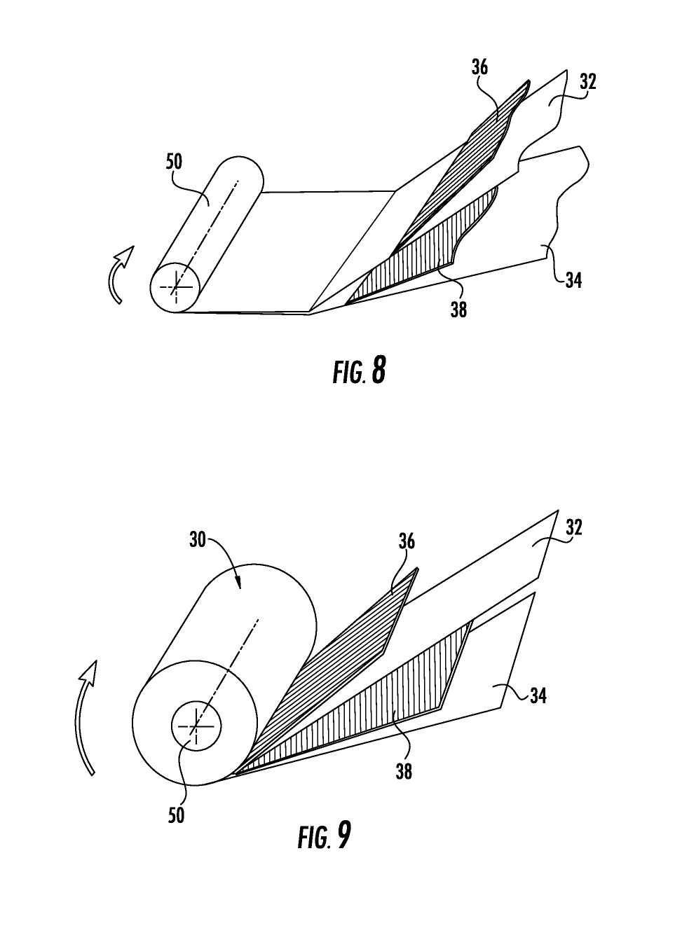

FIGS. 6-7 illustrate an exemplary embodiment of a wound cell element 30 (e.g., a jelly roll) in which electrodes 36, 38 and separators 32, 34 (not shown) are wound around a member or element provided in the form of a mandrel 50 (e.g., a body, center member, shaft, rod, tube etc.). According to an exemplary embodiment, an adhesive or tape 48 (e.g., as shown in FIG. 6) may be used to position an insulative wrap 46 (e.g., as shown in FIG. 4) around the cell element 30 in order to at least partially electrically insulate the cell element 30 from the housing 25.

According to an exemplary embodiment, the mandrel 50 is provided in the form of an elongated hollow tube 52 and is configured to allow gases from inside the electrochemical cell to flow from one end of the electrochemical cell (e.g., the top) to the other end of the electrochemical cell (e.g., the bottom). According to another exemplary embodiment, the mandrel 50 may be provided as a solid tube.

The mandrel 50 is illustrated, for example, in FIG. 7 as being provided within the center of the cell element 30. According to an exemplary embodiment, the mandrel 50 does not extend all the way to the very top and bottom of the cell element 30. According to other exemplary embodiments, the mandrel 50 may extend all the way to the top and/or bottom of the cell element 30.

Still referring to FIGS. 6-7, according to an exemplary embodiment, the mandrel 50 includes at least one (i.e., one or more) element or drive member 60 joined to an end of the hollow tube 52. According to an exemplary embodiment, the drive members 60 are configured to electrically insulate the hollow tube 52 from the electrodes 36, 38. According to another exemplary embodiment, the hollow tube 52 may be provided in electrical contact with one of the electrodes while being electrically insulated from the other electrode. For example, according to an exemplary embodiment, the hollow tube 52 may be electrically coupled to the positive electrode 36 (or negative electrode 38), while the hollow tube 52 is electrically isolated from the negative electrode 38 (or positive electrode 36) by the drive member 60.

According to an exemplary embodiment, the drive members 60 are formed from an insulative material such as a polymeric material or other suitable material (e.g., a plastic resin) and the hollow tube 52 is formed from an electrically (and thermally) conductive material such as a metallic material or other suitable material (e.g., aluminum or aluminum alloy). According to another exemplary embodiment, the drive members 60 are formed from an electrically (and thermally) conductive material such as a metallic material or other suitable material (e.g., aluminum or aluminum alloy) and the hollow tube is formed from an insulative material such as a polymeric material or other suitable material (e.g., a plastic resin). According to another exemplary embodiment, both the drive members 60 and the hollow tube 52 are formed from an insulative material such as a polymeric material or other suitable material (e.g., a plastic resin).

Referring now to FIGS. 8-9, the assembly of a cell element 30 is shown according to an exemplary embodiment. Although not shown in detail, the mandrel 50 is represented schematically in FIGS. 8-9. In FIG. 8, separators 32, 34 are attached to the mandrel 50 with double-face or double-sided tape (or with another suitable adhesive or attachment means), after which the separators 32, 34 are wound around the mandrel 50 (e.g., two or more turns of the mandrel 50). According to the exemplary embodiment shown in FIG. 8, two turns of the mandrel 50 uses 72 mm of the length of the separators 32, 34, but may use more or less according to other exemplary embodiments. An end of the negative electrode 38 (i.e., a leading edge) is then placed between separators 32, 34, after which an end (i.e., a leading edge) of the positive electrode 36 is placed on top of separator 32 (although the order in which the positive and negative electrodes 36, 38 are inserted between the separators 32, 34 may vary according to other exemplary embodiments).

In this manner, a layered structure is formed in which the positive and negative electrodes 36, 38 are separated from each other by separators 32, 34 (and may be offset from each other in the manner described with respect to FIG. 5). Additionally, the leading edge of the positive electrode 36 is offset from the leading edge of the negative electrode 38 by a distance known as a negative electrode overlap. In the exemplary embodiment shown, the negative electrode overlap of the leading edges is 40 mm (although this may vary according to other exemplary embodiments).

The separators 32, 34 and electrodes 36, 38 are then wound around the mandrel 50 to form the wound cell element 30 by inserting a driver (not shown) into a drive member 60 of the mandrel 50 and rotating the driver to turn the mandrel 50. According to an exemplary embodiment, the driver may extend entirely through the drive member 60 or may extend only partially into the drive member 60. According to another exemplary embodiment, the driver may extend entirely through mandrel 50 and engage both of the drive members 60. In this case, both of the drive members 60 should be aligned with one another in order to properly receive the driver.

According to an exemplary embodiment, two drivers (not shown) may be used to drive the mandrel 50 (e.g., one at either end of the mandrel 50 such that each driver is inserted into its own drive member 60). According to another exemplary embodiment, only a single driver (not shown) may be used to drive or rotate the mandrel 50. In this embodiment, the single driver is inserted into a first drive member 60 of the mandrel 50 with the opposite end of the mandrel 50 being received or engaged by a freely rotating spindle. In this case, the non-driven end of the mandrel 50 (i.e., the end not receiving the driver) may or may not have a second drive member 60.

FIG. 9 illustrates a cell element 30 as it appears near the end of the winding operation (the mandrel 50 is shown as the center of the wound cell element 30, about which the electrodes 36, 38 and separators 32, 34 are wound). The trailing edge of the positive electrode 36 is offset from the trailing edge of the negative electrode 38 by a predetermined distance (e.g., according to an exemplary embodiment, the distance is 20 mm, although this may vary according to other exemplary embodiments). The separators 32, 34 are then wound a further two turns to ensure that there is no contact between the positive and negative electrodes 36, 38. Although the exemplary embodiments as shown and described with respect to FIGS. 8-9 refer to specific values for the various overlapping lengths of the separators, it should be noted that these values may vary according to other exemplary embodiments. According to another exemplary embodiment, the mandrel 50 may be removed from the completed assembly before the cell element 30 is inserted into the cell housing 25.

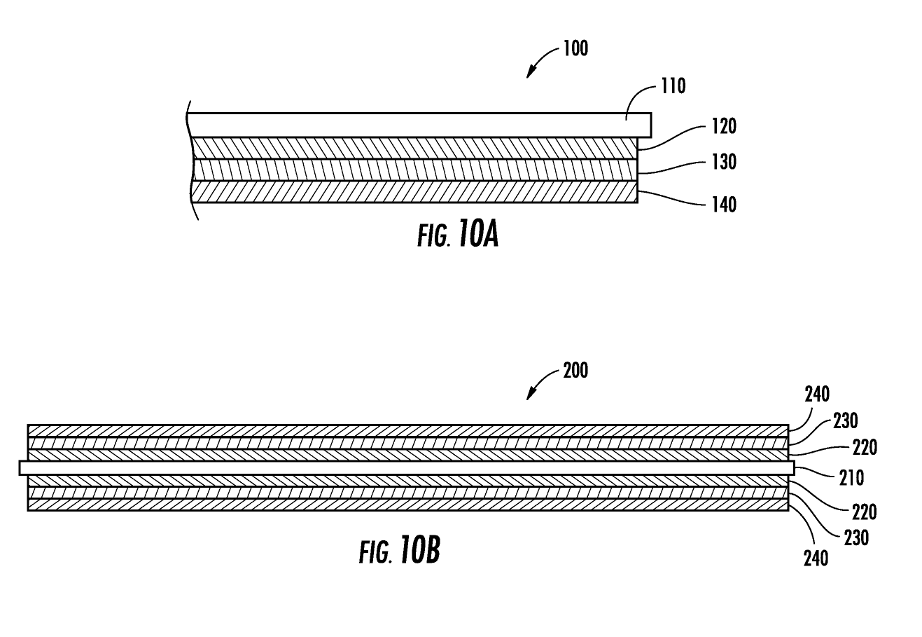

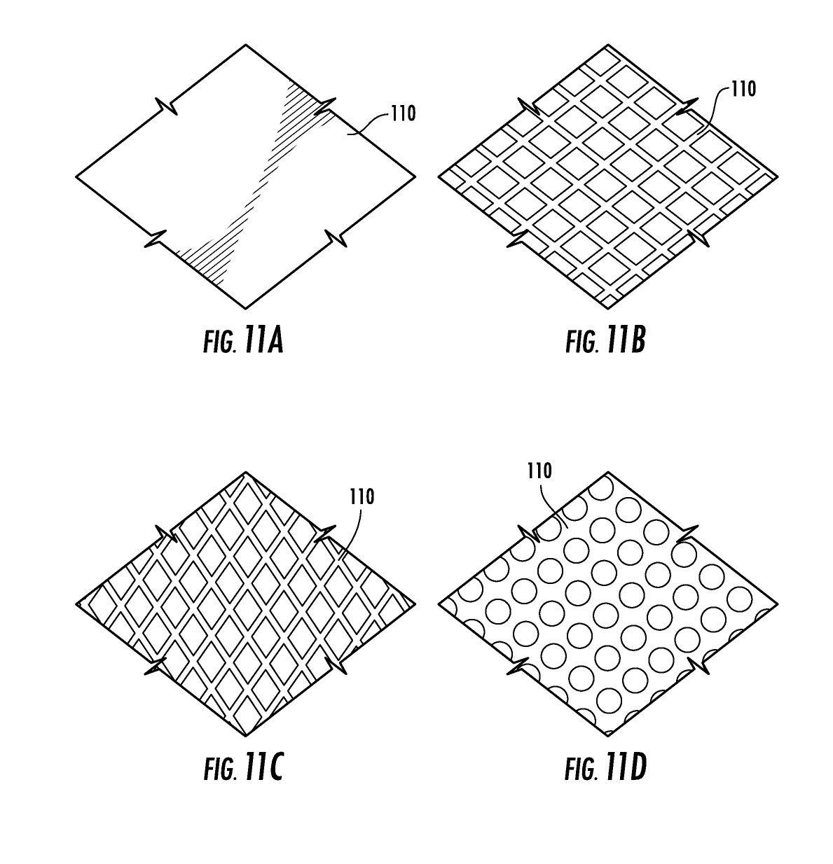

FIG. 10A illustrates a cross-section of an electrode 100 according to an exemplary embodiment. The electrode 100 includes a first or base layer 110 (e.g., a substrate), a second layer 120, a third layer 130, and a fourth layer 140. According to an exemplary embodiment, the electrode 100 includes a non-conductive substrate that has a number of other conductive layers provided thereon. The non-conductive substrate is configured to act as a lightweight, inexpensive base for the remaining conductive layers.

According to an exemplary embodiment, the first layer 110 includes a nonconductive material such as a polymer (e.g., polyethylene, polypropylene, polyester, etc.) or another suitable material. According to one exemplary embodiment, the first layer 110 includes a polymer film such as Mylar®. According to an exemplary embodiment, the first layer 110 has a thickness of between approximately 4 and 30 micrometers, but may have a greater or lesser thickness according to other exemplary embodiments.

According to an exemplary embodiment, the second layer 120 includes a conductive material such as a metal, and is configured to act as a current collector (e.g., conductive support, conductor, etc.) for the electrode 100. According to an exemplary embodiment, the conductive material may be for example, aluminum, copper, titanium nickel, gold, silver, or other suitable material or alloy thereof. According to an exemplary embodiment, the second layer 120 has a thickness of between approximately 1 and 5 micrometers, but may have a greater or lesser thickness according to other exemplary embodiments.

According to another exemplary embodiment, the second layer 120 is formed by providing the conductive material onto the first layer 110 (e.g., form a metallized polymer sheet). According to one exemplary embodiment, the conductive material is deposited onto the first layer 110 by electroplating the conductive material onto the first layer 110. For example, an electrical current may be passed through a solution containing the conductive material (e.g., as dissolved metal ions having a positive charge) and the object to be plated. The positively charged metal ions are deposited on the object to be plated (which has a negative charge).

According to another exemplary embodiment, the conductive material is deposited onto the first layer 110 using a vapor deposition process (e.g., physical vapor deposition, electron bean vapor deposition, sputter deposition, cathodic arc deposition) or other suitable process. For example, in physical vapor deposition, the conductive material may be deposited onto the surface of the first layer 110 by condensation of a vaporized form of the conductive material to form a thin layer of the conductive material on the surface of the first layer 110.

According to another exemplary embodiment, the first layer 110 and the second layer 120 may be laminated (e.g., hot laminated) together. For example, the first layer 110 and the second layer 120 may pressed (e.g., compressed, rolled, forced, etc.) together under heat so that the first layer 110 and the second layer 120 adhere to one another. According to one exemplary embodiment, an adhesive or transition layer may be added in between the first layer 110 and the second layer 120.

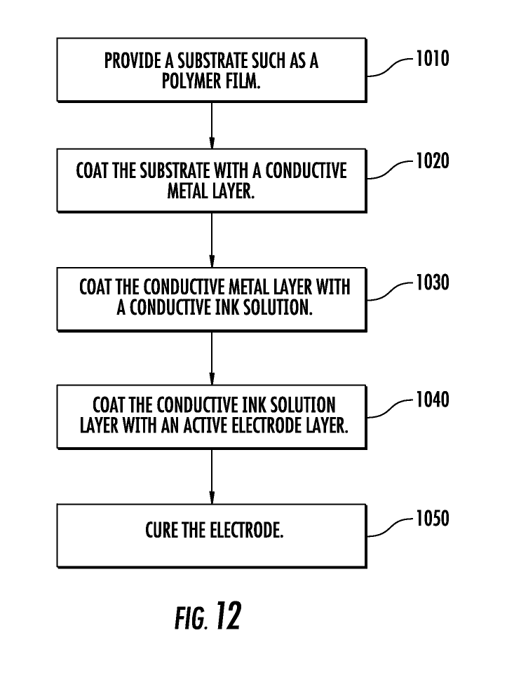

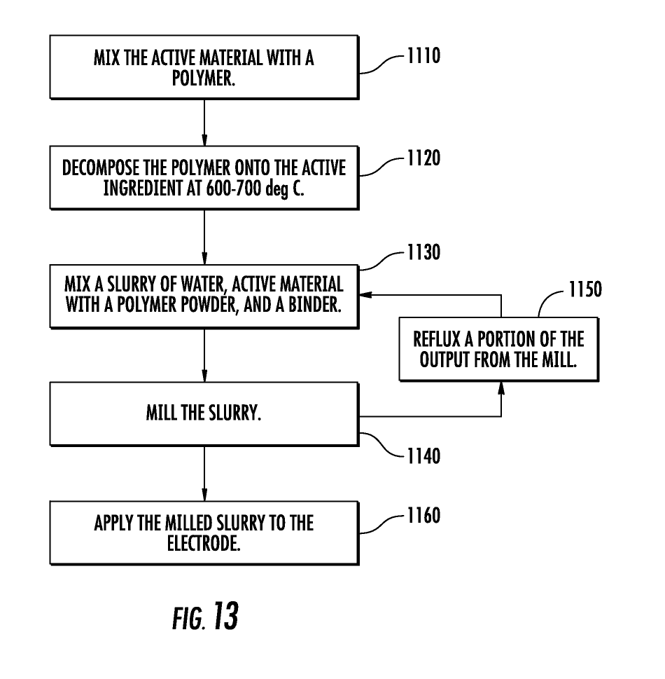

According to another exemplary embodiment, the first layer 110 may include a grid-like configuration (or other non-solid pattern). For example, the first layer 110 may include a plurality of apertures or holes provided throughout the first layer 110 (see, e.g., FIGS. 11A-11D). According to various exemplary embodiments, the holes may be in the shape of a diamond, square, oval, circle, rhomboid, rectangle, hexagon, or any other suitable shape or combination of shapes. According to an exemplary embodiment, the holes may have a size (e.g., diameter) of less than 5 mm, but may have a greater or lesser size according to other exemplary embodiments.

Where a grid-like structure is used for the first layer 110, the conductive material of the second layer 120 may be deposited on the grid-like structure of the first layer 110. According to an exemplary embodiment, the conductive material is provided (or allowed to flow) around the grid-like structure such that the conductive material adheres to itself to provide a strong mechanical bond (e.g. to avoid delamination).

One advantageous feature of the electrode as shown in FIGS. 10A-11D is that the material cost and the overall weight of the battery module 20 may be reduced by reducing the amount of purified metal foils in the electrodes 100 (e.g., through the use of an inexpensive polymer substrate coupled to a thin conductive layer).

According to still another embodiment, the first layer 110 and the second layer 120 may be replaced with a thin metallic foil or other suitable material. For example, a thin metallic foil (e.g., aluminum, copper, or alloy thereof) may take the place of the first layer 110 and the second layer 120.

According to an exemplary embodiment, the third layer 130 includes a material configured to aid or enhance the adhesion of the fourth layer 140 to the second layer 120, and may also include a conductive material (e.g., such as graphite, carbon, carbon black, etc.). According to an exemplary embodiment, the third layer 130 has a thickness of between approximately 1 and 5 micrometers, but may have a greater or lesser thickness according to other exemplary embodiments.

According to an exemplary embodiment, the third layer 130 may be an ink or ink-like solution of an adhesive binder and a conductive material (e.g., carbon). According to another exemplary embodiment, the third layer may be a water-based solution of an adhesive binder and conductive material (e.g., carbon) that is coated in a thin layer on the surface of the second layer 120. The adhesive binder may include a water soluble binder, such as polyacrylic acid, or other binder such as styrene butyl rubber or difluoro-polyvinylidene (PVFD) or PVDF copolymer.

According to an exemplary embodiment, a conductive carbon material, such as, for example, carbon black, is combined with the adhesive binder to provide a conductive layer that serves as the interface between the second layer 120 and the fourth layer 140. According to an exemplary embodiment, the third layer 130 is a conductive ink that is commercially available from Acheson Colloids, of Port Huron, Michigan as EB-012.

According to another exemplary embodiment, the adhesive binder may be a polyethylene or polypropylene, or any other suitable material that may be hot melted onto the surface of the conductive second layer 120. Other materials and/or methods of the application may be used according to various alternative embodiments.

According to one exemplary embodiment, the third layer 130 is applied to the second 120 to improve the conductivity as well as the adhesion of the fourth layer 140 to the second layer 120. According to an exemplary embodiment, the third layer 130 has a conductivity that is higher than the conductivity of the fourth layer 140 (i.e., the active electrode layer) such that the third layer 130 does not act as an electrical barrier. According to a particular exemplary embodiment, the conductivity of the third layer 130 is approximately 2-3 times higher than the conductivity of the fourth layer 140, but may have greater or lesser conductivity according to other exemplary embodiments. In one embodiment, the conductivity of the third layer 130 is approximately 30 mΩ/cm², but may have a greater or lesser conductivity according to other exemplary embodiments.

According to one exemplary embodiment, the third layer 130 may be coated (e.g., painted, sprayed, etc.) onto the conductive metal layer 120 to achieve a thin layer (e.g., between approximately 1 and 5 micrometers). According to an alternative exemplary embodiment, the third layer 130 may be applied using a gravure coating process. In gravure coating, a solution or coating (e.g., the ink solution containing the adhesive binder and conductive carbon) may be applied to a metal to be welded, where certain portions of the metal may be masked (and remain as bare metal) from being gravure coated (e.g., by adding spacers to the application rollers used in the coating process to prevent the rollers from taking up the coating in certain areas).

According to another embodiment, the third layer 130 may be applied as a solution using other printing processes rather than a coating process (e.g., to increase processing speeds up to, for example, 160 meters per minute) to achieve a relatively thin layer. According to another exemplary embodiment, the third layer 130 may be applied to the second layer 120 using a lithographic process or other suitable process.

According to an exemplary embodiment, the fourth layer 140 includes an active electrode material. According to one exemplary embodiment, the fourth layer 140 includes an active material intended for use as part of a negative electrode or anode (such as, e.g., carbon, graphite, lithium titanium oxide, a mix of silicon and carbon, tin oxide, a mix of tin oxide blended with carbon, or other suitable material). According to another exemplary embodiment, the fourth layer 140 includes an active material intended for use as part of a positive electrode or cathode (such as, e.g., a lithium metal oxide or other suitable material). According to an exemplary embodiment, the lithium metal oxide may be, for example, a lithium manganese oxide, a lithium cobalt oxide, a lithium nickel cobalt aluminum oxide, a lithium nickel cobalt manganese oxide, or other suitable metal oxide. According to an exemplary embodiment, the fourth layer 140 has a thickness of between approximately 20 and 150 micrometers, but may have a greater or lesser thickness according to other exemplary embodiments.

FIG. 10B illustrates a cross-section of an electrode 200 according to another exemplary embodiment. The electrode includes a conductive layer 220, a conductive ink layer 230, and an active electrode layer 240, all provided on both sides of a base layer or substrate 210. According to one exemplary embodiment, one of the active electrode layers 240 is a positive electrode material (e.g., lithium metal oxide) and the opposite active electrode layer 240 is a negative electrode material (e.g., carbon or graphite). According to another exemplary embodiment, the two active electrode layers 240 may be the same active electrode materials (e.g., both positive or both negative active materials).

According to an exemplary embodiment, the thicknesses of the various layers of FIG. 10B are similar to the thicknesses of similar layers discussed with respect to FIG. 10A. According to an exemplary embodiment, the processes and methods of applying the various layers to one another of FIG. 10B are similar to the methods and processes discussed with respect to FIG. 10A.

FIG. 12 is a flow diagram illustrating one embodiment of a method of forming the electrode 100 shown in FIG. 10A. In a first step 1010, a first or base layer 110 (e.g., substrate) such as a polymer film is provided. In a second step 1020, the substrate 110 is coated with a conductive layer 120. In a third step 1030, a conductive ink layer 130 (such as a conductive ink solution), is then applied to the conductive layer 120. According to an exemplary embodiment, the conductive ink solution 130 may be cured (e.g., for less than 1 hour at a temperature of between approximately 200 and 250 degrees Celsius) after the conductive ink solution 130 is applied to the conductive layer 120.

In a fourth step 1040, an active electrode material layer 140 is applied to the conductive ink solution 130 (e.g., by a knife over roll process, precision die process, slot die process, comma bar process or other suitable process). In a fifth step 1050, the electrode 100 is cured or dried (e.g., for between approximately 4 and 8 hours at a temperature of between approximately 100 and 150 degrees Celsius). According to an exemplary embodiment, the curing or drying processes may occur under a vacuum to aid in the removal of water. The electrode 100 may then be wound (in the case of a cylindrical cell), stacked (in the case of a prismatic cell), or otherwise formed before being inserted into a housing 25. According to an exemplary embodiment, separators (e.g., separators 32, 34 as shown in FIGS. 8-9) may be alternating placed between the negative and positive electrodes before being wound, stacked, etc.

In some embodiments, the active material may be formed as a paste or slurry that is applied to the third layer (e.g., the conductive ink layer). According to an exemplary embodiment, the paste is cured or dried to form the electrode (e.g., for between approximately 4 and 8 hours at a temperature of between approximately 100 and 150 degrees Celsius). According to other exemplary embodiments, the curing process may have a greater or lesser curing time, and/or occur at a greater or lesser temperature. According to another exemplary embodiment, the performance of cells (e.g., lithium-ion cells, nickel metal hydride cells, etc.) may be further enhanced by creating thin active electrode layers using the various processes (or combination of processes) as described below.

As shown in FIG. 13, according to an exemplary embodiment, the slurry is made by first mixing (e.g., in a tray, such as a flat tray) the active material (e.g., the positive or negative active electrode material) with a polymer (step 1110). According to an exemplary embodiment, both the active material and the polymer are in the form of a dry powder. According to an exemplary embodiment, the mixture is between 90 and 99% active material, with the balance being polymer, but the percentage of active material in the mixture may be greater or lesser according to other exemplary embodiments. According to an exemplary embodiment, the active material and the polymer are combined in a high shear mixing process to form a substantially homogeneous mixture.

According to an exemplary embodiment, the active material may be a negative electrode material (such as, e.g., carbon, graphite, lithium titanium oxide, a mix of silicon and carbon, tin oxide, a mix of tin oxide blended with carbon, or other suitable material). According to another exemplary embodiment, the fourth layer 140 includes a positive electrode material (such as, e.g., a lithium metal oxide or other suitable material). According to an exemplary embodiment, the lithium metal oxide may be, for example, a lithium manganese oxide, a lithium cobalt oxide, a lithium nickel cobalt aluminum oxide, a lithium nickel cobalt manganese oxide, or other suitable metal oxide.

According to various exemplary embodiments, the polymer is polyethylene glycol (PEG), polyethylene oxide (PEO), polyethylene (PE), and/or carboxymethyl cellulose (CMC) derivatives. The polymer is decomposed (e.g., burned, etc.) to form a layer of carbon on the surface of the active material. This may be done by a rapid heat treatment (typically for less than one hour) at temperatures of between approximately 600 and 700 degrees Celsius in an inert atmosphere (step 1120). According to various exemplary embodiments, the length of time and/or temperature of the heat treatment may be greater or lesser depending on the desired effect. By decomposing the polymer onto the active material, a thin uniform layer of conductive carbon is formed on the surface of the active material.

According to an exemplary embodiment, the active material (having the conductive carbon layer) is then mixed in a slurry with water and a binder (step 1130). According to various exemplary embodiments, the binder may be polyacrylic acid, styrene butyl rubber, PVDF, CMC, or other suitable material. With the use of this conductive layer, the amount of additional carbon added into the slurry for electrode fabrication may be reduced without compromising the high power performance of the electrochemical cell.

According to an exemplary embodiment, a slurry of water, active material (e.g., that may or may not be coated with decomposed polymer powder as described above) and binder is mixed (e.g., in a slurry mixing tank). The slurry is then passed through a media mill (e.g., comprising a relatively hard media material past which the slurry is rotated) to reduce the size of active material granules (step 1140). A portion of the mix is then refluxed and re-mixed with the remaining slurry in the slurry mixing tank (step 1150). The process is repeated until the desired consistency, particle size, etc., of the slurry is obtained. The milled slurry is then applied to the electrode (step 1160).

According to one embodiment, the particle size of the active material is reduced in the presence of all of the electrode slurry components, with the intent of minimizing the amount of fines (small particles) produced. According to an exemplary embodiment, the average particle size of the active material is between approximately 1 and 5 micrometers, but may have a greater or lesser diameter according to other exemplary embodiments. According to one exemplary embodiment, a final coated active electrode layer of between approximately 20 and 40 micrometers is desired, but may have a greater or lesser thickness according to other exemplary embodiments.

According to various exemplary embodiments, the media material is a hardened zirconium compound or stainless steel between approximately 3 mm and 10 mm in diameter, but may have a greater or lesser diameter according to other exemplary embodiments. The media material is sized to be large enough to not pass through a filter with the slurry and small enough to reduce the active material granules to the desired size. According to one exemplary embodiment, the media mill is rotated at a speed of between approximately 1000 and 5000 rpm, but may have a greater or lesser speed according to other exemplary embodiments. The percentage of slurry that is refluxed back to the mixing tank is determined by a variety of factors, such as the speed of the mill, time spent in the mill, size of the mill vs. the size of the mixing tank, etc.

The media milling process serves to coat the active materials with carbon while reducing the particle size of the agglomerated active material. The milling process also improves the dispersion of the carbon into the slurry, allowing for reduced amounts of solvent to be used. Also, particle size reduction of the electrode active materials may be achieved, thereby avoiding many of the problems associated with more traditional approaches. Limiting the degree or number of fines produced is achieved through the operation of the media mill (e.g., the size of media particles used in the media mill, the rotational speed of the media mill, the type of media mill used (e.g., sand, disc, peg, etc.), the pumping rate through the media mill, etc.). Reducing the amount of fines tends to increase battery life, as the fines (smaller particles) tend to decompose faster than the larger particles. According to various exemplary embodiments, the media milling process may be used with an electrode having a polymer substrate or with an electrode not having a polymer substrate.

According to another exemplary embodiment, the electrode processing method is modified by adding plasticizing agents to the electrode slurry to achieve thin electrode layers for high power applications. The inherent brittleness of electrode layers can present a limitation to the ability to tightly wrap and compress electrode coils to fit into relatively narrow containers such as the one shown in FIG. 4. The brittleness of these folded layers can lead to cracks and defects at the center of the cell winds. The flexibility of electrodes, particularly desirable for relatively thin, prismatic wrap cell configurations, may be improved through the addition of an electrochemically stable plasticizing additive to the electrode slurry.

According to one embodiment, the use of minimal amounts of the plasticizer (e.g., less than 10% by weight) may minimize the impact on cell energy density. Handling of the coated electrodes may be done inside a dry room atmosphere to prevent moisture adsorption of the plasticizer. Suitable plasticizers may include: ethylene carbonate, polycarbonate, di-methyl adipates, and combinations thereof. According to a preferred embodiment, the plasticizing agents are left in the final electrode and therefore are chosen to be electrochemically inactive.

According to another exemplary embodiment, the active electrode layer 140 (e.g., as shown in FIG. 5A) may be formed by coating a thin layer of a water-based solution containing an adhesive binder (e.g., polyacrylic acid), an active material, and conductive carbon onto the conductive metal layer 120. According to an exemplary embodiment, the electrode layer 140 is thermally cured at a temperature greater than 100 degrees Celsius for at least approximately 15 minutes. According to another exemplary embodiment, the electrode layer 140 is thermally cured at a temperature greater than approximately 90 degrees Celsius for between approximately 3 and 10 minutes. According to another exemplary embodiment, the electrode layer 140 is thermally cured at a temperature between approximately 200 and 250 degrees Celsius for at least approximately 30 minutes. Thermally curing the adhesive binder in this range improves the stability of the adhesive binder in the presence of electrolytes used in lithium-ion systems by inducing cross-linking in the binder.

Formation of the active electrode layer 140 using the water-based solution replaces the step of mixing the active material in a slurry and then coating the conductive metal layer 120 with the slurry mixture. The use of polyacrylic acid for the binder may help achieve good adhesion to the conductive metal layer 120 for the formation of a thin film thickness.

As can be readily understood from this disclosure, the performance of electrodes used in high power applications may be enhanced by implementing one or more of the modifications to the fabrication process of electrodes that are discussed herein. These modifications include: applying a conductive ink coating to the current collector to enhance adhesion and conductivity of the electrode layer; reducing the amount of purified metal foils in the battery (e.g., through the use of metallized polymers, etc.); modifying the processing of the electrode (e.g., through the use of a media mill, plasticizing agents, etc.) to achieve thin electrode layers for high performance; and thermally curing adhesion-enhanced layers to increase stability and adhesion of the layer(s).

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

The construction and arrangement of the elements of the electrode for a battery shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. An electrode for an electrochemical cell comprising:
a polymer substrate;
a conductive material in contact with the polymer substrate;
a conductive ink in contact with the conductive material; and
an active electrode material in contact with the conductive ink;
wherein the conductive ink is configured to enhance the adhesion between the conductive material and the active electrode material.

2. The electrode of claim 1, wherein the polymer substrate comprises at least one material selected from the group consisting of polypropylene, polyethylene, and polyester.

3. The electrode of claim 1, wherein the conductive material comprises at least one material selected from the group consisting of aluminum, copper, and alloys thereof.

4. The electrode of claim 1, wherein the conductive ink comprises at least one material selected from the group consisting of polyacrylic acid, styrene butyl rubber, and difluoro-polyvinylidene.

5. The electrode of claim 4, wherein the conductive ink further comprises at least one material selected from the group consisting of graphite, carbon, and carbon black.

6. The electrode of claim 1, wherein the active electrode material comprises at least one material selected from the group consisting of lithium nickel aluminum cobalt oxide, lithium nickel cobalt manganese oxide, and lithium iron phosphate oxide.

7. The electrode of claim 1, wherein the polymer substrate comprises a plurality of apertures to form a grid-like configuration.

8. The electrode of claim 7, wherein the apertures of the polymer substrate have at least one shape selected from the group consisting of square, diamond, and circle.

9. An electrochemical cell comprising an electrode comprising:
a polymer substrate;
a conductive material provided on the polymer substrate;
a conductive ink provided on the conductive material; and
an active electrode material provided on the conductive ink;
wherein the conductive ink is configured to enhance the adhesion between the conductive material and the active electrode material.

10. The electrochemical cell of claim 9, wherein the polymer substrate comprises at least one material selected from the group consisting of polypropylene, polyethylene, and polyester.

11. The electrochemical cell of claim 9, wherein the conductive material comprises at least one material selected from the group consisting of aluminum, copper, and alloys thereof.

12. The electrochemical cell of claim 9, wherein the conductive ink comprises at least one material selected from the group consisting of polyacrylic acid, styrene butyl rubber, and difluoro-polyvinylidene and at least one material selected from the group consisting of graphite, carbon, and carbon black.

13. The electrochemical cell of claim 9, wherein the active electrode material comprises at least one material selected from the group consisting of lithium nickel aluminum cobalt oxide, lithium nickel cobalt manganese oxide, and lithium iron phosphate oxide.

14. The electrochemical cell of claim 9, wherein the polymer substrate comprises a plurality of apertures to form a grid-like configuration, wherein the apertures have at least one shape selected from the group consisting of square, diamond, and circle.

15. A method of making an electrode for an electrochemical cell, the method comprising:
providing a conductive material on a polymer substrate;
providing a conductive ink on the conductive material; and
providing an active electrode material on the conductive ink;
wherein the conductive ink is configured to enhance the adhesion between the conductive material and the active electrode material.

16. The method of claim 15, wherein the conductive material is provided on the polymer substrate using at least one of an electroplating and vapor deposition process.

17. The method of claim 15, further comprising passing the active electrode material through a media mill before providing it to the conductive ink.

18. The method of claim 15, further comprising decomposing a polymer material onto the surface of the active electrode material prior to mixing the active electrode material in a slurry.

19. The method of claim 15, further comprising adding a plasticizer to the active electrode material prior to providing the active electrode material to the conductive ink.

20. The method of claim 15, further comprising curing the electrode for between 4 and 8 hours at a temperature of between 100 and 150 degrees Celsius.
